(19) United States
(12) Patent Application Publication
(10) Pub. No.: US 2005/0286009 A1
(43) Pub. Date: Dec. 29, 2005

(54) Glass substrate for packing liquid crystals, method for manufacturing same, and LCD device using same

(75) Inventors: Takeo Nakagawa, Tokyo (JP); Masayuki Muranaka, Tokyo (JP)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/142,552

(22) Filed: Jun. 1, 2005

(30) Foreign Application Priority Data
Jun. 25, 2004 (CN) 200410027908.8

(51) Int. Cl. G02F 1/1333

(52) U.S. Cl. 349/158

(57) ABSTRACT

A glass substrate for packing liquid crystals includes a mechanically treated surface covered by a transparent coating. This ensures that the glass substrate has a high transparence. A method for manufacturing such a glass substrate includes the steps of: (a) providing an original glass substrate including a mechanically treated surface having a plurality of dents; and (b) forming a transparent coating on the surface to fill the dents. The steps can be completed in a relatively short time, and thus the manufacturing cost is reduced. An LCD device using such glass substrates includes a plurality of liquid crystals and two glass substrates packing the liquid crystals therebetween.

### BACKGROUND OF THE INVENTION

The present invention relates to glass substrates for packing liquid crystals, methods for manufacturing such glass substrates, and LCD (liquid crystal display) devices using such glass substrates.

Liquid crystal display devices are widely used in computers, mobile telephones, digital cameras and so on. A main part of a typical liquid crystal display device is a panel structure, which includes two glass substrates and a plurality of liquid crystals packed between the glass substrates. In order to meet the light-weight and thin structure needs of modern liquid crystal displays, the glass substrates are required to be as thin as possible.

Generally, a method for manufacturing the panel structure of the liquid crystal display device is as follows. Firstly, a pair of glass substrates is provided, with a plurality of liquid crystals already packed therebetween. Then, the glass substrates are partially dissolved by chemical means or partially cut by mechanical means to become thin glass substrates. In practice, thin glass substrates produced by chemical means generally do not have high smoothness, therefore mechanical means are in widespread use. The procedure involving mechanical means generally includes the steps of grinding and cutting the glass substrate using a grinding wheel.

However, a thin glass substrate produced by mechanical means often has a plurality of dents formed on a surface thereof. This reduces the transparence of the thin glass substrate. In order to ensure that the thin glass substrate has high transparence, it needs to be precisely and finely ground. The step of precise and fine grinding is time-consuming, and increases the manufacturing cost of the glass substrate.

What is needed, therefore, is a glass substrate that has high transparence and a low cost.

What is also needed is a method for manufacturing the above-described glass substrate.

What is further also needed is an LCD device that uses a pair of the above-described glass substrates.

### SUMMARY

In a preferred embodiment, a glass substrate includes a mechanically treated surface having a plurality of dents, and a transparent resin coating formed on the surface to fill the dents. A roughness of the surface is in the range from 0.1 to 3 micrometers. In the preferred embodiment, the roughness of the surface is in the range from 0.1 to 0.2 micrometers. The resin coating can be a photocurable resin coating, and a thickness thereof is in the range from 0.5 to 5 micrometers.

In another embodiment, a method for manufacturing such a glass substrate includes the steps of: (a) providing a glass substrate including a mechanically treated surface having a plurality of dents; and (b) forming a transparent resin coating on the surface to fill the dents. The resin coating is formed on the surface by means of immersion or by means of spin coating.

In a further embodiment, an LCD device includes a plurality of liquid crystals, and two of the above-described glass substrates packing the liquid crystals therebetween.

Compared with a conventional glass substrate manufacturing method, the preferred method of the present invention provides a transparent resin coating 352 directly formed on the mechanically treated surface 350 of the glass substrate 35. The glass substrate 35 has high transparence. The method can be completed in a relatively short time, and thus the manufacturing cost is reduced. Furthermore, the transparent resin coating 352 can enhance the strength and toughness of the glass substrate 35. Thus, the glass substrate 35 is less liable to be damaged or broken.

Other advantages and novel features will become more apparent from the following detailed description when taken in conjunction with the accompanying drawings, in which:

### BRIEF DESCRIPTION OF THE DRAWINGS

FIG. 1 is a schematic, cross-sectional view of an LCD device in accordance with a preferred embodiment of the present invention; and

FIG. 2 is an enlarged view of a circled portion II of FIG. 1.

### DETAILED DESCRIPTION OF PREFERRED EMBODIMENTS

Reference will now be made to the drawings to describe preferred embodiments of the present invention in detail.

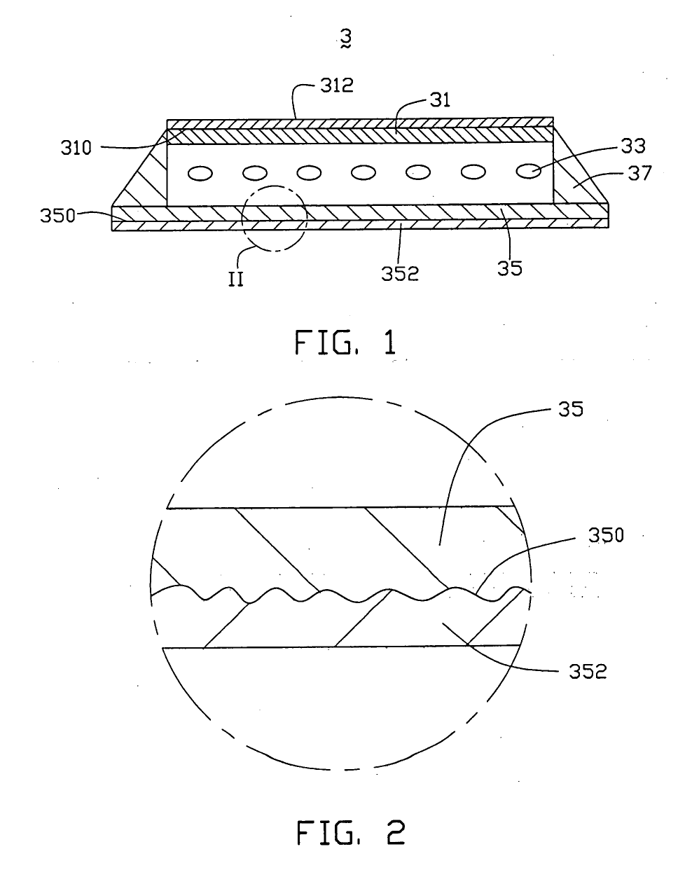

Referring to FIG. 1, a liquid crystal display (LCD) device 3 in accordance with a preferred embodiment of the present invention is shown. The LCD device 3 includes a plurality of liquid crystals 33, two glass substrates 31, 35, and packing materials 37. The liquid crystals 33 are disposed between the glass substrates 31, 35. The packing materials 37 are disposed between the glass substrates 31, 35 at corresponding four side extremities thereof, thereby forming a sealed space. The glass substrate 31 has a transparent coating 312 formed on an outer surface 310 thereof, and the glass substrate 35 has a transparent coating 352 formed on an outer surface 350 thereof.

The glass substrates 31, 35 have similar structures, and are manufactured using similar methods. Hereinafter, for brevity, the structure and the manufacturing method of the glass substrate 35 only will be described.

Referring to FIG. 2, an enlarged view of part of the glass substrate 35 is shown. The surface 350 of the glass substrate 35 has a plurality of dents (not labeled) formed thereon, and the coating 312 formed on the surface 350 fills the dents.

A method for manufacturing the glass substrate 35 with the transparent coating 352 thereon includes the steps of: (a) providing the glass substrate 35 including the surface 350 having a plurality of dents; and (b) forming the transparent coating 352 on the surface 350 to fill the dents.

The glass substrate 35 is obtained by mechanically treating a glass plate which is larger than the glass substrate 35. A grinding wheel is generally adopted to grind and cut the glass plate to achieve the glass substrate 35 having the needed size and shape. This generally includes grinding the surface 350 and forming the dents thereon. After the mechanical treatment process, the glass substrate 35 is wiped clean to remove dirt from the surface 350.

A roughness of the surface 350 is in the range from 0.1 to 3 micrometers. In the preferred embodiment, the roughness of the surface 350 is in the range from 0.1 to 0.2 micrometers. The particular transparent coating 352 is chosen according to the particular glass substrate 35 used. The refractive index and expansion coefficient of the transparent coating 352 are similar to those of the glass substrate 35. In the preferred embodiment, the transparent coating 352 is a photocurable resin coating, and a thickness thereof is in the range from 0.5 to 5 micrometers. The transparent resin coating 352 is formed on the surface 350 by means of immersion or by means of spin coating. Then the transparent resin coating 352 is irradiated by ultraviolet radiation until it is cured.

Compared with a conventional glass substrate manufacturing method, the preferred method of the present invention provides a transparent resin coating 352 directly formed on the mechanically treated surface 350 of the glass substrate 35. The glass substrate 35 has high transparence. The method can be completed in a relatively short time, and thus the manufacturing cost is reduced. Furthermore, the transparent resin coating 352 can enhance the strength and toughness of the glass substrate 35. Thus, the glass substrate 35 is less liable to be damaged or broken.

It is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

1. A glass substrate for packing liquid crystals, comprising:
a mechanically treated surface having a plurality of dents; and
a transparent resin coating formed on the surface to fill the dents.

2. The glass substrate as claimed in claim 1, wherein a roughness of the surface is in the range from 0.1 to 3 micrometers.

3. The glass substrate as claimed in claim 2, wherein the roughness of the surface is in the range from 0.1 to 0.2 micrometers.

4. The glass substrate as claimed in claim 1, wherein the resin coating is a photocurable resin coating.

5. The glass substrate as claimed in claim 4, wherein a thickness of the photocurable resin coating is in the range from 0.5 to 5 micrometers.

6. A method for manufacturing liquid crystal display device, comprising the steps of:
(a) preparing a transparent substrate;
(b) packing liquid crystals beside the substrate so as to integrate the liquid crystals with the substrate;
(c) thinning the packed substrate from an outer surface thereof;
(d) directly forming a transparent coating on the outer surface of the substrate right after the thinning step without other treatments;
(e) equipping the packed substrate inside the liquid crystal display device.

7. The method as claimed in claim 6, wherein a roughness of the outer surface of the substrate in step (a) is in the range from 0.1 to 3 micrometers.

8. The method as claimed in claim 7, wherein the roughness of the surface of the substrate in step (a) is in the range from 0.1 to 0.2 micrometers.

9. The method as claimed in claim 6, wherein in step (d), the coating is formed on the outer surface by means of immersion or by means of spin coating.

10. The method as claimed in claim 6, wherein the coating is a photocurable resin coating.

11. The method as claimed in claim 6, wherein a thickness of the coating is in the range from 0.5 to 5 micrometers.

12. A liquid crystal display device comprising:
a plurality of liquid crystals; and
two glass substrates packing the liquid crystals therebetween, each glass substrate comprising a mechanically treated surface having a plurality of dents, and a transparent resin coating formed on the surface to fill the dents.

13. The liquid crystal display device as claimed in claim 12, wherein a roughness of the surface is in the range from 0.1 to 3 micrometers.

14. The liquid crystal display device as claimed in claim 13, wherein the roughness of the surface is in the range from 0.1 to 0.2 micrometers.

15. The liquid crystal display device as claimed in claim 12, wherein the resin coating is a photocurable resin coating.

16. The liquid crystal display device as claimed in claim 15, wherein a thickness of the photocurable resin coating is in the range from 0.5 to 5 micrometers.
